(19) United States
(12) Patent Application Publication
(10) Pub. No.: US 2013/0166360 A1
(43) Pub. Date: Jun. 27, 2013

(54) USER CENTRIC GROUP BUYING DEALS

(71) Applicants: Sanjay Kshetramade, Fremont, CA (US); Rajen Subba, Mountain View, CA (US)

(72) Inventors: Sanjay Kshetramade, Fremont, CA (US); Rajen Subba, Mountain View, CA (US)

(73) Assignee: YAHOO! INC., Sunnyvale, CA (US)

(21) Appl. No.: 13/333,563

(22) Filed: Dec. 21, 2011

(51) Int. Cl. G06Q 30/02

(52) U.S. Cl. 705/14.1

(57) ABSTRACT

Techniques for facilitating group discounts are described. A shopping request is received from a user. Information related to the shopping request is provided to a plurality of providers. A plurality of group discount packages is received from the plurality of providers. The group discount packages are generated based on the provided shopping request information. The group discount packages may be offered by enabling users to accept at least one of the group discount packages. A deal with at least one of the plurality of group discount packages with a corresponding at least one of the providers is confirmed when an associated threshold value is met.

### BACKGROUND OF THE INVENTION

1. Field of the Invention

The present invention relates to online deals and incentives.

2. Background

For many years, customers have been able to shop for products and services. Traditionally, a customer has been able to purchase a product or service from a merchant. The merchant may occasionally offer discounts on their products and/or services. Such discounts may benefit customers with lower prices, and may benefit merchants with an increase in sales volumes, enabling excess inventory to be reduced among other benefits. In some cases, a merchant may offer a group discount to a group of customers desiring a particular product or service. Examples of such group discount include vacation package deals or tickets to museums for a family or groups of ten or more persons.

In recent years, the Internet has provided a new medium for customers to purchase products and services from merchants. For example, thousands of electronic commerce websites such as amazon.com provided by Amazon.com, Inc. of Seattle, Wash., and ebay.com, provided by eBay Inc. of San Jose, Calif., have been established that sell products and services over the Internet. The availability of products and services for sale of the Internet has made shopping more convenient for customers and has enabled merchants to reach larger numbers of customers.

Some websites have recently been providing coupons for discounted products and services to groups of users over the Internet. Examples of such websites include groupon.com, provided by Groupon, Inc. of Chicago, Ill. and livingsocial.com provided by LivingSocial of Washington, D.C. Some of these websites provide coupons that are activated if a predetermined minimum number of persons sign up for a particular deal. For instance, a discounted price for a single product or service maybe offered to users, and if a predetermined number of users sign up for the offer, then the deal becomes available to all users. If the number of users that signed up for the offer is fewer than the predetermined number of users, then the offer is retracted and is not available to any user.

### BRIEF SUMMARY OF THE INVENTION

Various approaches are described herein for, among other things, providing group discounts to users. In a group discount, a group discount package is configured based on information related to shopping requests received from one or more users. The group discount package is offered to a population of users, and a deal for the group discount package is confirmed when an associated threshold value is met.

In a method implementation, a shopping request is received from a user. The information related to the shopping request is provided to a plurality of providers. The providers may generate a plurality of group discount packages based on the provided information. The group discount packages are offered to the user by enabling the user to accept at least one of the group discount packages. A deal is confirmed for a group discount package with a corresponding provider when an associated threshold value is met.

The shopping request may include an indication of an “item” the user is interested in purchasing, such as a specific product, a product type, a service, a provider, or a brand. The user may also indicate a budget indicating a maximum amount of money the user is willing to spend in the shopping request. The group discount package includes coupon(s) indicating one or more of a particular purchase value, a discount on a specific product, a discount on a service, a discount on a category of products, a discount on a category of services, etc. The group discount package further includes an associated threshold value representing a predetermined number of user requests to purchase a particular group discount package before the deal is confirmed for the particular group discount package.

In a system implementation, a group discounting system includes a package configuration module. The package configuration module generates a first user interface that enables a shopping request to be received from a user. The package configuration module further generates a second user interface that enables information relating to the shopping request to be presented to providers and enables the providers to generate a plurality of group discount packages based on information from the shopping request.

The group discounting system may further include a group discount offering engine. The group discount offering engine is configured to offer the plurality of group discount packages to the user. The group discount offering engine enables the user to accept at least one of the group discount packages. The group discount offering engine confirms a deal for a group discount package with a corresponding provider when an associated threshold value is met.

Computer program products are also described herein that enable group discount packages to be configured and offered to users based on shopping requests received from the users, as well as enabling further embodiments described herein.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 shows a block diagram of a communication system for offering group discounts, according to an example embodiment.

FIG. 2 shows a flowchart providing a process for offering group discounts, according to an example embodiment.

FIG. 3 shows a block diagram of a group discounting system, according to an example embodiment.

FIG. 4 shows a block diagram of a server configured to enable a group discount package to be configured, according to an example embodiment.

FIG. 5 shows a block diagram of a display at a provider device used to display a shopping request of a corresponding user, according to an example embodiment.

FIG. 6 shows a block diagram of a server configured to conduct a group discount offer with a population of users, according to an example embodiment.

FIG. 7 shows a block diagram of a display at a user device used to display a group discount package offered by a provider, according to an example embodiment.

FIG. 8 shows a flowchart providing a process for forming a group of users, according to an example embodiment.

FIG. 9 shows a process for providing statistic(s) about users within a group of users, according to an example embodiment.

FIG. 10 shows a process for enabling a user to share a group discount package with other users, according to an example embodiment.

FIG. 11 shows a block diagram of a group discount offering engine that enables a user to share group discount packages with other users, according to an example embodiment.

FIG. 12 shows a flowchart providing a process for collecting a fee from one or more providers, according to an example embodiment.

FIG. 13 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Numerous exemplary embodiments of the present invention are described as follows. It is noted that any section/subsection headings provided herein are not intended to be limiting. Embodiments are described throughout this document, and any type of embodiment may be included under any section/subsection.

Websites exist that provide coupons for discounted products and services, such as groupon.com and livingsocial.com. Some of these websites provide coupons that are activated or confirmed if a predetermined minimum number of persons sign up for a particular deal (e.g., a “Groupon®”). For instance, a provider may offer a discounted price for a product or service to users. The offer may be made to the users by email or other communication. If a predetermined number of users sign up for the offer, then the deal is confirmed and becomes available to all of the users. If the predetermined number of users is not reached, such as when the number of users that sign up for the offer is fewer than the predetermined number, the offer is retracted from all of the users.

However, such techniques for providing coupons have limitations because these techniques are based on a push model where providers generate deals or offers, and the users have to accept or not accept them. These techniques do not specifically consider the interest of the users in the generation of the deals.

In embodiments, improved techniques are provided for online shopping using a pull model where users express their shopping interests by specifying the type of deals they want to purchase. These improved techniques enable providers to receive information related to the shopping interests of the users and generate offers that are based on these shopping interests. In an embodiment, an online shopping system is provided that enables group discount packages to be provided to users, based on their shopping requests. If one or more associated threshold values is/are met, all of the users may purchase a particular group discount package. As described above, current shopping/sales techniques involve offers of products or services generated by providers without any specific input from the users.

Embodiments provide improvements over current shopping techniques, such that users are able to let the providers know what they want. The users can collectively work in a larger group of similar users/shoppers to entice/bargain with providers for better deals. By knowing what the users want and how many users are interested, the providers can better customize their offers to the needs of the users to further entice the users to purchase from them. The providers can receive instant conversion/foot-traffic (because the user buy-in to the deal of their preference once the merchants offer their deals). The providers are also provided with the ability to target deals to users that may not have specified their store as a potential place to shop. An entity that centrally manages the discounting shopping offers (between the users and providers) may receive a portion of the revenue generated by users accepting the deals. Furthermore, the entity may be able to use shopping preference, interest, and/or intent information from the users to display advertisements to the users and/or use in further types of advertisement targeting products. Because users can refer friends to offered deals, such referral activity can be used to indicate the shopping interests of the friends as well.

### A. Example Group Discounting System Embodiments

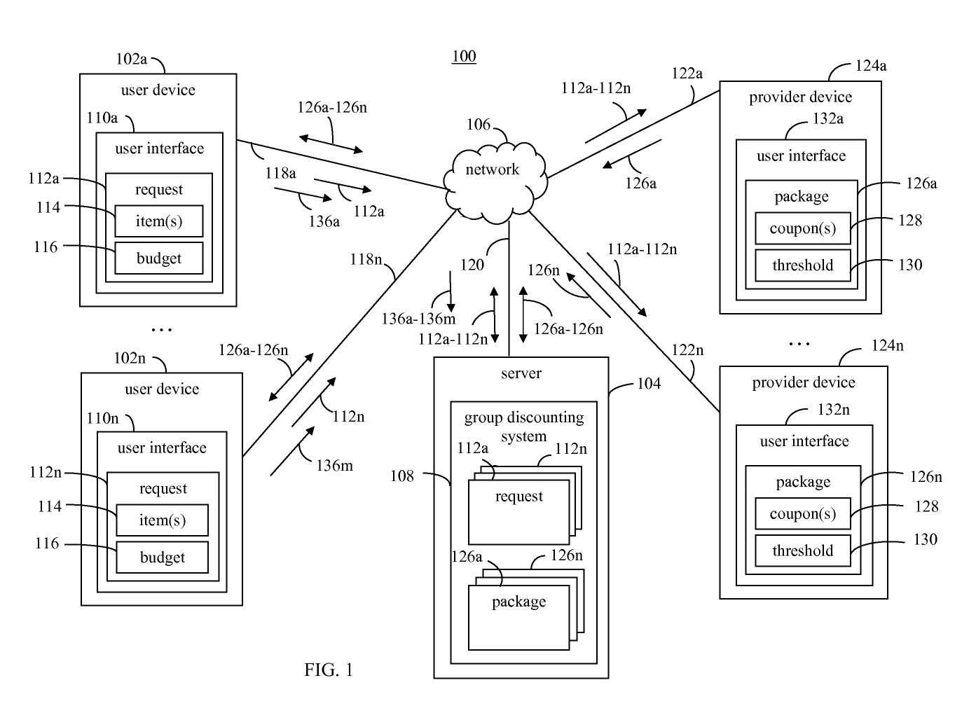

Embodiments may be implemented in a variety of environments. For instance, FIG. 1 shows a block diagram of a communication system 100 in which group discounts may be offered, according to an example embodiment. Environment 100 is shown for purposes of illustration, and embodiments may be implemented in other environments, as would be apparent to persons skilled in the relevant art(s) from the teachings herein. As shown in FIG. 1, system 100 includes first-n^{th} user devices 102a-102n, a server 104, a network 106, and first-n^{th} provider devices 124a-124n. Furthermore, server 104 includes a group discounting system 108. System 100 is described as follows.

User devices 102a-102n and provider devices 124a-124n may each be any type of stationary or mobile computing device, including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a netbook, etc.), a smart phone (e.g., an Apple iPhone, a Google Android™ phone, a Microsoft Windows® phone, etc.), or other type of computing device. Server 104 may be implemented in one or more computer systems, including one or more servers, which may be any type of computing device described herein or otherwise known that is capable of enabling the corresponding functionality described herein.

User devices 102a-102n and server 104 are communicatively coupled with each other through network 106. Provider devices 124a-124n and server 104 are also communicatively coupled with each other through network 106. Network 106 may be a LAN (local area network), a WAN (wide area network), or any combination of networks, such as the Internet. User devices 102a-102n are each coupled with network 106 through a corresponding one of communication links 118a-118n, provider devices 124a-124n are each coupled with network 106 through a corresponding one of communication links 122a-122n, and server 104 is coupled with network 106 by communication link 120. Communication links 118a-118n, 122a-122n, and 120 may each include wired and/or wireless links. Examples of communication links 118a-118n, 122a-122n, and 120 include IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB (universal serial bus) links, etc.

Group discounting system 108 is configured to receive shopping requests from users. For example, as shown in FIG. 1, group discounting system 108 may enable a plurality of shopping requests 112a-112n to be received from user devices 102a-102n. User devices 102a-102n may each include a corresponding one of user interfaces 110a-110n that is used to configure and display shopping requests 112a-112n of a user. For instance, user interfaces 110a-110n may each include a graphical user interface (GUI), such as a user interface provided by an email tool, by an application, by a web browser, etc. User interfaces 110a-110n enable shopping requests 112a-112n to be configured, adjusted, and/or displayed to the users before they are transmitted to group discounting system 108. Each of shopping requests 112a-112n includes one or more “item(s)” 114 that a corresponding user is interested in purchasing, such as a specific product, a product type, a service, a provider, or a brand. Shopping requests 112a-112n may further include a budget 116 indicating a maximum amount of money the corresponding user is willing to spend.

Shopping requests 112a-112n may be provided to server 104 using any suitable communication technique, such being transmitted in an email message, in a text message, in a social network message, by filling a form in a web page, in a message displayed by an application (e.g., by an application executing in a desktop computer, a web application hosted in a browser, an “app” at a mobile device, etc.), or in another manner.

As shown in FIG. 1, group discounting system 108 of server 104 receives shopping requests 112a-112n. Group discounting system 108 is configured to provide information relating to the received shopping requests to one or more providers (e.g., merchants, salespeople, advertisers, etc.). For example, as shown in FIG. 1, group discounting system 108 may transmit information associated with shopping requests 112a-112n to provider devices 124a-124n.

In response to providing information associated with shopping requests 112a-112n to provider devices 124a-124n, group discounting system 108 receives one or more group discount packages from providers at provider devices 124a-124n. These group discount packages may be generated based on information associated with the shopping requests received from group discounting system 108. For example, as shown in FIG. 1, group discount packages 126a-126n may be configured by corresponding provider devices 124a-124n (e.g., by individuals, by companies, etc.) based on information relating to shopping requests 112a-112n. In an embodiment, provider devices 124a-124n may each include a corresponding one of user interfaces 132a-132n that are used to provide (e.g., display) information relating to the received shopping requests 112a-112n, and to enable the providers to configure group discount packages 126a-126n.

For instance, user interfaces 132a-132n may each include a graphical user interface (GUI), such as a user interface provided by an email tool, by an application, by a web browser, etc. The display of the received information of shopping requests 112a-112n may include one or more items of interest to the users and associating budget amounts. The information of shopping requests 112a-112n may be displayed on user interfaces 132a-132n in a similar manner as they are displayed on user interfaces 110a-110n or in any other data format that may be generated by server 104 or as specified by the providers. Group discount packages 126a-126n at provider devices 124a-124n each include group discount criteria as configured by the corresponding provider, including an indication of one or more coupon(s) 128 that may be purchased by users, one or more threshold values 130, and/or further information of a group discount package. For example, a coupon 128 of a package may indicate at least one of a particular purchase value, a discount on a specific product, a discount on a service, a discount on a category of products, or a discount on a category of services. Each group discount packages 126a-126n includes an associated threshold value 130. Threshold value 130 indicates a threshold value for a particular package that when achieved causes the package to be confirmed. Various types of threshold values may be used, including a threshold value representing a predetermined minimum number of users to request to purchase a particular group discount package.

As shown in FIG. 1, server 104 receives group discount packages 126a-126n from provider devices 124a-124n. Group discounting system 108 is configured to enable group discounts to be offered to users by enabling the users to accept at least one of the group discount packages. For example, as shown in FIG. 1, group discounting system 108 may enable group discount packages 126a-126n to be transmitted as offers to users at user devices 102a-102n. Group discount packages 126a-126n may be transmitted in one or more communication signals through network 106 to user devices 102a-102n. Group discount packages 126a-126n may be transmitted in an email message, in a text message, in a “tweet” (e.g., provided by Twitter, Inc. of San Francisco, Calif.), in a social network message, in a web page, in a message displayed by an application (e.g., by an application executing in a desktop computer, a web application hosted in a browser, an “app” at a mobile device, etc.), or in another manner. As shown in FIG. 1, group discount packages 126a-126n are received for display to users at user devices 102a-102n.

The users at user devices 102a-102n may each accept or reject the offered group discount packages. For instance, to accept an offer of group discount package 126a a user may request to purchase it. As shown in FIG. 1, one or more of user devices 102a-102n may transmit a response indicating acceptance of one or more of group discount packages 126a-126n to group discounting system 108, shown as responses 136a-136m from user devices 102a-102n. The number of responses 136a-136m may be the same or different from the number of users that were offered group discount packages 126a-126n. Responses relating to group discount packages 126a-126n each indicate that a user at corresponding user devices 102a-102n requested to purchase one or more of group discount packages 126a-126n.

Group discounting system 108 receives responses 136a-136m relating to group discount packages 126a-126n, and determines whether to confirm a deal with the responding users based on received responses 136a-136m. For instance, group discounting system 108 may determine whether the minimum purchase number thresholds for each group discount packages 126a-126n are met. Group discounting system 108 may confirm the deal for one or more of group discount packages 126a-126n with the corresponding providers when the associated threshold values 130 for the group discount packages 126a-126n are met, and the responding users are enabled to receive the group discount packages that they requested to purchase at the discounted purchase price(s). Furthermore, group discounting system 108 does not confirm a deal for the remaining group discount packages associated with thresholds 130 that have not been met, and no user may be able to purchase these group discounting packages having the unmet thresholds.

### B. Embodiments for Offering Group Discounts

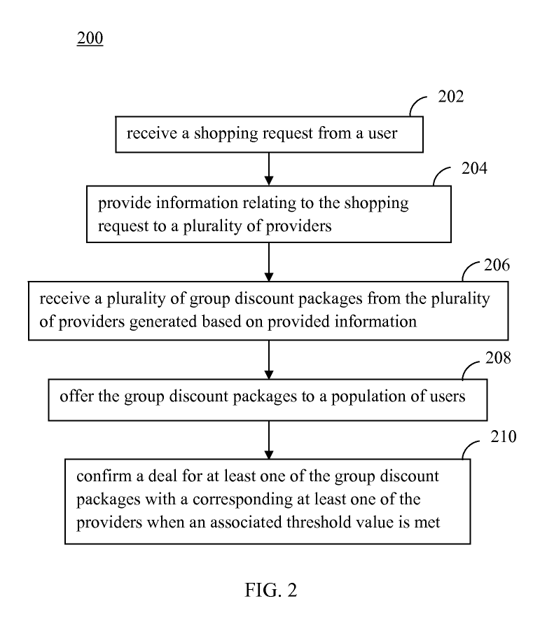

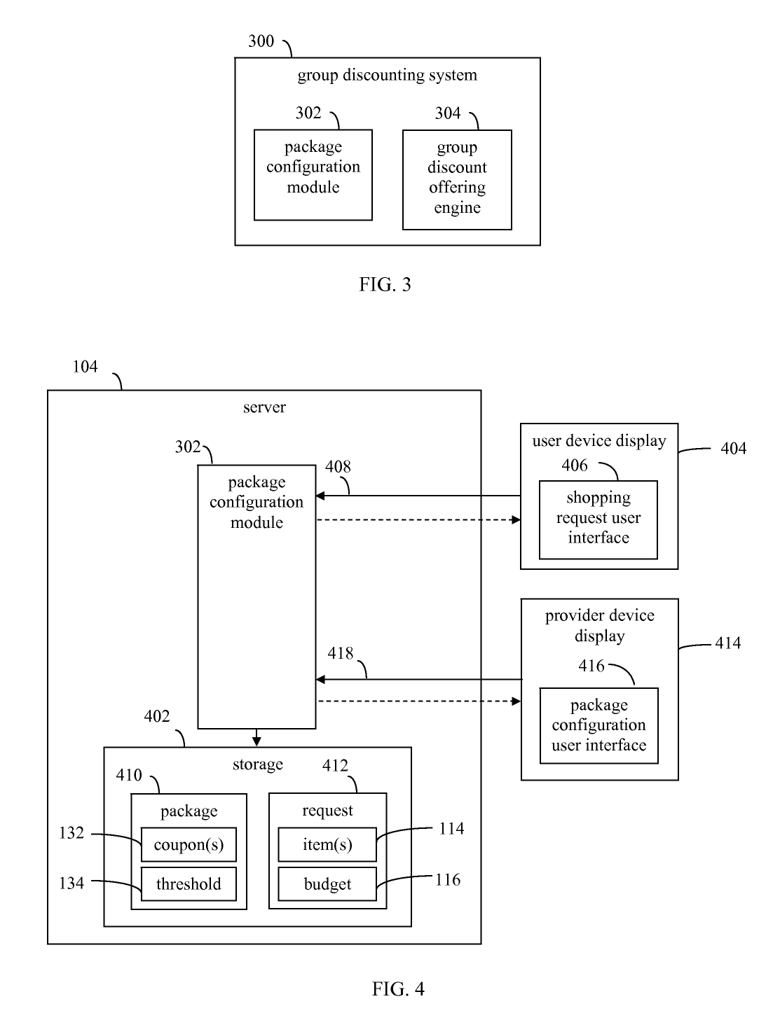

In embodiments, group discounting system 108 of communication system 100 may operate in various ways to facilitate group discounts. For instance, FIG. 2 shows a flowchart 200 providing a process for offering group discounts, according to an example embodiment. In an embodiment, group discounting system 108 may operate according to flowchart 200. FIG. 3 shows a block diagram of a group discounting system 300, according to an example embodiment. Group discounting system 300 is an example of group discounting system 108. As shown in FIG. 3, group discounting system 300 includes a package configuration module 302 and a group discounting offering engine 304. Flowchart 200 is described with respect to group discounting system 300 for illustrative purposes. Further structural and operational embodiments will be apparent to persons skilled in the relevant art(s) based on the following description of flowchart 200 and group discounting system 300.

Flowchart 200 begins with step 202. In step 202, a shopping request is received from a user. For example, in an embodiment, package configuration module 302 may enable users to submit shopping requests that include item(s) they wish to purchase and budgets indicating the amount of money they are willing to spend on shopping sprees.

Package configuration module 302 of FIG. 3 may be implemented in various ways. For instance, FIG. 4 shows a block diagram of server 104 of FIG. 1 configured to facilitate group discount packages, according to an example embodiment. As shown in FIG. 4, server 104 includes a data storage 402 and package configuration module 302 communicatively connected to a user device display 404 and a provider display 414. In an embodiment, package configuration module 302 may generate a shopping request user interface 406 that is displayed by user device display 404 (or by another display). User interface 406 is configured to enable a user to configure and transmit a shopping request to package configuration module 302.

For instance, a user of server 104, of one of user devices 102a-102n in FIG. 1, or of another computing device may desire to generate a shopping request. Package configuration module 302 may enable the user to generate a shopping request by providing shopping request user interface 406 to the user. Shopping request user interface 406 may be provided to the user in any manner, such as serving a web page of a website to which the user has navigated that is hosted by package configuration module 302, in an email message, or in other manner. Shopping request user interface 406 is displayed by user device display 404 to the user. The user may interact with shopping request user interface 406 to configure and/or transmit a shopping request. For instance, shopping request user interface 406 may contain one or more user interface elements, such as text entry boxes, check boxes, pull down menus, etc., that enable the user to configure the shopping request. The user may be enabled to input various shopping request information, such as a name for a shopping request, an indication of one or more items that the user wants to purchase, an indication of a budget that the user is willing to spend on an offer, an indication of an expiration date and/or time for the shopping request, and/or further shopping request information. Additionally or alternatively, the user may be able to use a search field to search for a particular product, service, or provider name to obtain a list meeting their constraints and may be enabled to select a product, service, or provider from that list. Shopping request user interface 406 may be displayed in any form, such as in a web browser window or as part of an application, etc.

As shown in FIG. 4, package configuration module 302 receives shopping request information 408 from shopping request user interface 406. Shopping request information 408 includes information input by the user for the shopping request being configured. Package configuration module 302 stores shopping request information 408 in storage 402 as a shopping request 412. As shown in FIG. 4, shopping request 412 indicates item(s) 114 (the one or more items that the user wants to purchase) and budget 116 (the amount of money the user is willing to spend on an offer). Shopping request 412 may subsequently be accessed in storage 402 to be provided to providers as described above and/or elsewhere herein.

Referring back to flowchart 200 in FIG. 2, in step 204, information relating to the shopping request is provided to a plurality of providers. Package configuration module 302 may provide information provided by users related to one or more shopping requests to providers in various ways. For instance, such information may be transmitted to providers in the form of one or more files or other data structures, emails, text messages, XML documents, etc.

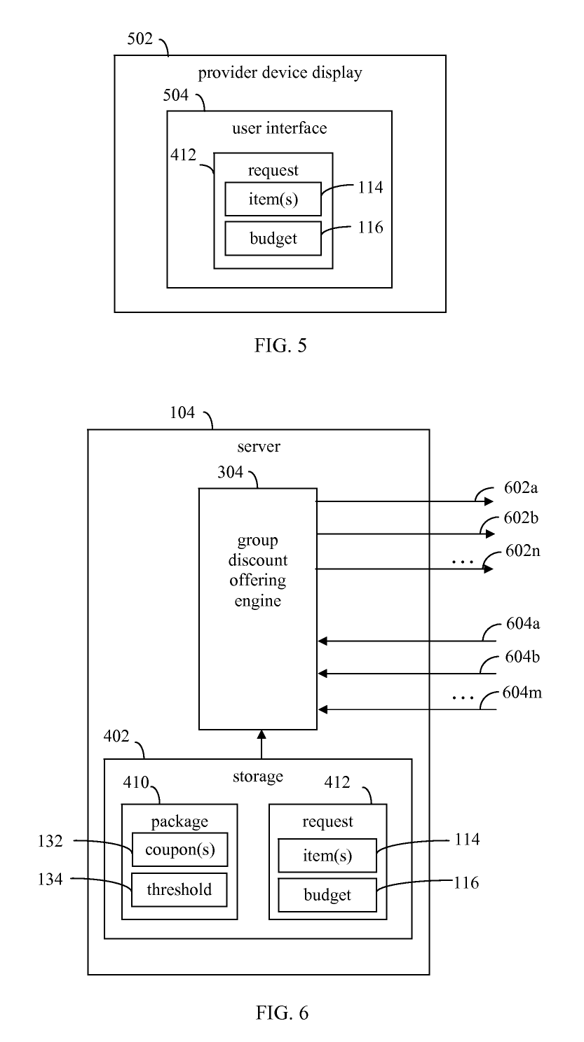

As shown in FIG. 4, a package configuration user interface 416 may be displayed to a provider by provider device display 414 at a provider device. User interface 416 is configured to enable information relating to shopping request information to be presented to providers and to enable the providers to generate group discount packages based on the received shopping requests. FIG. 5 shows a block diagram of a provider device display 502 used to display a shopping request received at a provider device, according to an example embodiment. As shown in FIG. 5, provider device displays a user interface 504, which may be textual or graphical user interface (GUI), such as a user interface provided by an email tool, by an application, by a web browser, by a text message interface, etc. User interface 504 displays shopping requests, such as shopping request 412 of FIG. 4, including an indication of one or more items that one or more users want to purchase, a budget amount, an optional indication of an expiration date and/or time, and/or further shopping request information.

Based on the received shopping request information, a provider may generate a group discount offer for the users. For instance, a group discount package may be generated by a provider interacting with package configuration user interface 416. The group discount package may be generated automatically or manually (e.g., by a person configuring the package using a user interface). Package configuration user interface 416 may provide one or more user interface elements, such as text entry boxes, check boxes, pull down menus, etc., that enable the provider to configure the group discount package. The provider may generate an offer of a group discount package that may include various offer information, including a name for the group discount package, an indication of one or more items that may be purchased in a coupon, an optional indication of original prices for the item(s), an indication of discount prices for the item(s), an indication of a purchase value (e.g., a voucher), an indication of any threshold values associated with the item(s) and/or group discount package, an optional indication of an expiration date and/or time for an offer of the group discount package, an optional indication of a minimum number of different items of the package when multiple items are present that a user has to purchase in to take part in an offer, an optional indication of any limitations associated with the group discount package (e.g., users can only purchase two coupon(s) each), and/or further package information. Package configuration user interface 416 may be displayed in any form, such as in a web browser window, in a window of an application, etc.

In step 206 of FIG. 2, a plurality of group discount packages, which are generated based on the provided information relating to the shopping request, are received from the plurality of providers. As shown in FIG. 4, package configuration module 302 receives package configuration information 418 from package configuration user interface 416. Package configuration information 418 includes package information input by the provider for the group discount package being configured. Package configuration module 302 stores the package information in a group discount package 410 in storage 402. As shown in FIG. 4, package 410 indicates one or more coupons 128 (group discount offer information such as an item, a discount price, an expiration date, etc.) and threshold 130. Group discount package 410 may subsequently be accessed in storage 402 to be offered to users as one of group discount packages 126a-126n as described above and/or elsewhere herein.

User device display 404, provider device display 414, and provider device display 502 (FIG. 5) may be any type of display mentioned elsewhere herein or otherwise known, including an LCD (liquid crystal display), an LED (light emitting diode) display, a plasma display, a CRT (cathode ray tube) display, etc. Storage 402 may include one or more of any type of storage mechanism including a magnetic (e.g., in a hard disk drive), an optical disk (e.g., in an optical disk drive), a magnetic tape (e.g., in a tape drive), a memory device such as a RAM (random access memory) device, a ROM (read-only memory) device, etc., and/or any other suitable type of storage medium.

Referring back to flowchart 200 in FIG. 2, in step 208, the group discount package is offered to a population of users. For example, in an embodiment, group discount offering engine 304 of FIG. 3 may be configured to offer a group discount package to a population of users, such as users of user devices 102a-102n (FIG. 1). The user population may include users that are members of a group discounting service (e.g., an online coupon system, etc.) associated with group discounting system 108, and/or may include users that are not members. Group discount offering engine 304 may be implemented in various ways. For instance, FIG. 6 shows a block diagram of server 104 of FIG. 1 configured to conduct a group discount offer with a population of users, according to an example embodiment. As shown in FIG. 6, server 104 includes group discount offering engine 304 and storage 402. Group discount offering engine 304 may access package 410 in storage 402 (e.g., where any number of packages, such as plurality of packages 126a-126n of FIG. 1, may be stored). Group discount offering engine 304 receives package 410 and offers the group discount described in package 410 to users.

For instance, as shown in FIG. 6, group discount offering engine 304 may transmit the offer to users in one or more communications, such as first-nth offer messages 602a-602n transmitted to a corresponding number of users in a user population. Offer messages 602a-602n may be transmitted in a same way or in different ways, including being transmitted in as email messages and displayed using an email tool, as text messages, as “tweets,” as social network messages, as a web page displayed in a web browser, as a message displayed by an application (e.g., by an application executing in a desktop computer, a web application hosted in a browser, an “app” at a mobile device, etc.), and/or in another manner User devices (e.g., user devices 102a-102n of FIG. 1) of the users may receive and display the respective offer message of first-nth offer messages 602a-602n so that the users may decide whether to participate in a particular deal.

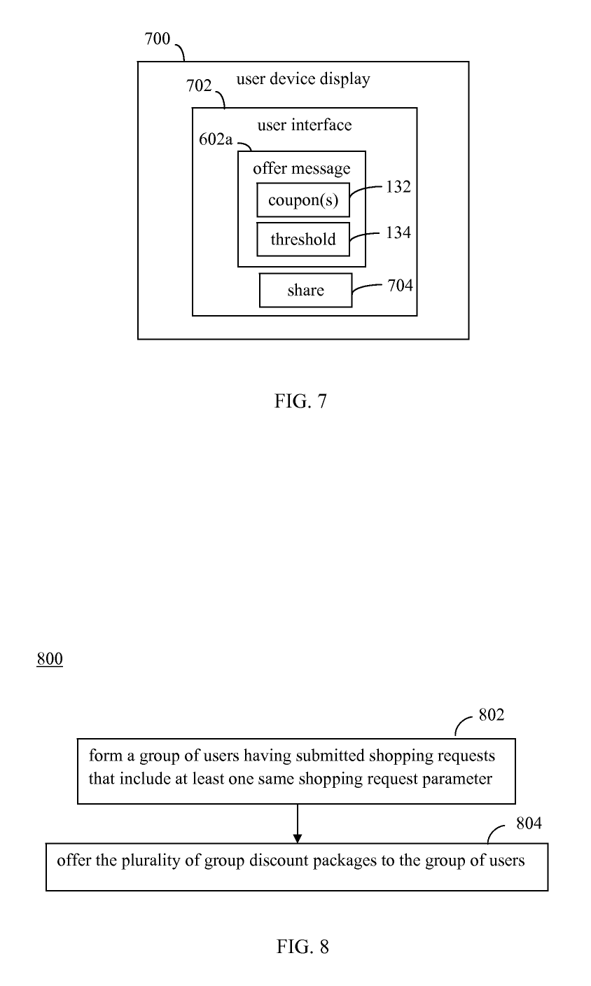

For instance, FIG. 7 shows a block diagram of a user device display 700 at a user device used to display offer message 602a to a corresponding user, according to an example embodiment. As shown in FIG. 7, display 700 displays a user interface 702, which may be a textual or graphical user interface (GUI), such as a user interface provided by an email tool, by an application, by a web browser, by a text message interface, etc. User interface 702 displays offer message 602a, including displaying information of the corresponding group discount offer, such as one or more of a name, an indication of one or more items that may be purchased, an indication of original prices for the item(s), an indication of discount prices for the item(s), an indication of any threshold values associated with the items and/or package, an indication of an expiration date and/or time, an indication of a minimum number of different items of the package (when multiple items are present) that a user has to purchase to take part in an offer, and/or further offer information. A user of the user device may interact with user interface 702 to participate in the offer provided by offer message 602a by selecting an associated package to accept/purchase.

For example, as shown in FIG. 6, group discount offering engine 304 may receive responses 604a-604m to offer messages 602a-602n from users in one or more communications. Responses 604a-604m may indicate that corresponding users of the population of users desired to participate in the offer, and may each indicate one or more of coupon(s) 132 that the corresponding user is requesting to purchase.

Referring back to flowchart 200 in FIG. 2, in step 210, a deal for at least one of the group discount packages with a corresponding at least one of the providers is confirmed when an associated threshold value is met. In an embodiment, group discount offering engine 304 is configured to confirm a deal associated with a package when each threshold value associated with coupon(s) 132 of the package and corresponding offer are met.

For instance, as shown in FIG. 6, group discount offering engine 304 may determine whether a deal associated with package 410 may be confirmed. Group discount offering engine 304 may determine whether responses 604a-604m for the offer corresponding to package 410 include a number of purchase requests that meet or exceed the purchase number threshold value(s) for each of coupon(s) 132 of package 410. If all of the threshold values set for coupon(s) 132 in package 410 have been equaled or exceed, group discount offering engine 304 may indicate that a deal with package 410 is confirmed. Group discount offering engine 304 may store an indication in storage 402 that the deal with package 410 is confirmed, and/or may store the confirmed indication elsewhere. Furthermore, group discount offering engine 304 may notify the provider of package 410 and each user that provided one of responses 604a-604m that the deal is confirmed. Group discount offering engine 304 may notify the provider and/or users that a deal is confirmed (or not confirmed) in any manner, including one or more of an email, a text message, a “tweet,” an indication on a web page, an indication in a member account of each provider and/or user, an indication provided by an application, an indication in user interface 702 of FIG. 7, and/or in another manner.

An illustrative example implementation of flowchart 200 is provided as follows. A user defines what he wants to purchase in the near future (e.g., item 114) and the amount he wants to spend on such purchase (e.g., budget 116) and submits this information in a request message to a group discount system, such as group discounting system 300 of FIG. 3. In this example, the item of purchase may be a television and the budget amount may be $1,000. The user may simply specify the television, or may use a search option to conduct a search for the television and obtain a list of providers that meet the search constraints. The user may optionally pick one or more merchants, such as Best Buy®, and submit his choice to the group discount system. The information relating to the request of the user (e.g., television and $1,000 budget) is received by the group discount system (e.g., by package configuration module 302) and forwarded, in the same format or a different format, to a plurality of providers, (e.g., Best Buy®), which may include a specific provider chosen by the user. The group discount system may receive similar requests from other users. At least some of the similar requests may also indicate products, such as televisions, and/or services desired to be purchased by the users, and may also provide budgets.

The group discount system (e.g., package configuration module 302) may aggregate all related shopping requests (e.g., requests that relate to the same or similar products and/or services) and provide the associated information to the plurality of providers. For instance, package configuration module 302 may perform a comparison of shopping requests, and may group together users having similar shopping parameters (as described elsewhere herein), such as users that desired to purchase a similar item (e.g., a particular television). Package configuration module 302 may generate information to provide to the providers that indicates a number of users in a group, one or more items that the group is interested in, and an average budget for the group and/or other budget information, and/or further information. For example, Best Buy® and one or more other providers may receive a message from the group discounting system indicating that there are 300 users who want to buy a television. Best Buy® and the other providers can use the provided information regarding the shopping preferences of the user to generate one or more group discount packages. The providers compete for users by offering deals independently of one another. For instance, Best Buy® may generate a deal of 30% off for purchases greater than $1,000 with a threshold value of 100 users, whereas another provider (e.g., Amazon®) may generate a deal for $50 off all televisions with a threshold value of 50 users.

The group discount packages are provided from the providers to the group discounting system (e.g., to package configuration module 302). These group discount packages are subsequently offered to the 300 users by the group discounting system (e.g., by group discount offering engine 304), and optionally to further users that may be interested. The users have the option of accepting one or more of the offers by providing an indication of their acceptances to the group discounting system (e.g., to group discount offering engine 304). In this example, if 100 or more users accept the deal offered by Best Buy® then the group discount system confirms the deal with Best Buy®. If 50 or more users accept the deal offered by Amazon® then the group discount system confirms the deal with Amazon®. The user may select to accept a single deal or more than one deal (e.g., both Amazon® and Best Buy® deals) depending on how the deals are structured by the providers and/or the group discount system.

Note that the above illustrative example is provided for purposes of illustration and is not intended to be limiting. Embodiments may be implemented with any number and different types of items as would be apparent to person skilled in the relevant art(s) from the teachings herein.

### C. Further Embodiments

In embodiments, group discount packages may be generated and may be participated in by groups of users. Groups of users may be formed in any manner known to those skilled in the relevant art(s) from the teachings herein. For instance, FIG. 8 shows a flowchart 800 providing a process forming a group of users to enable sharing according to an example embodiment. Further structural and operational embodiments will be apparent to persons skilled in the relevant art(s) based on the following description of flowchart 800.

Flowchart 800 begins with step 800. In step 802, a group of users is formed from users having submitted shopping requests that include at least one same shopping request parameter. For example, as described above with respect to FIG. 4, a user may interact with shopping request user interface 406 to indicate or search for items of interest to the user and associate such items with shopping request 412. For instance, as described above with respect to FIG. 6, shopping requests 412 are processed by group discount offering engine 304 to determine a group of users having the same or similar shopping request parameters. These parameters include specific items or categories of items the users want to purchase, budget amounts set by the users, optional expiration dates and/or times for the shopping request, optional geographical area preferences, specific brand names or names of providers, etc. Group discount offering engine 304 may use any or all of these parameters to form a group of users. For example, group discount offering engine 304 may enable users who indicated a particular provider at which they wanted to shop (in person or online), such as Nordstrom, Inc. of Seattle, Wash., to form a group. In another example, group discount offering engine 304 may enable users to form a group of users who indicated a geographical preference for a deal, such as a spa deal in San Francisco. In this manner, users are enabled to form their own groups to secure deals that are most attractive to them.

As such, in one embodiment, the group of users may be formed automatically (e.g., by group discount offering engine 304) based on user preferences gathered from users of the group of users. Users having one or more same or similar user preferences may be automatically added to a group. For example, user preference information may include location information (e.g., a location of users extracted from IP (Internet Protocol) addresses), shopping preferences (e.g., preferred stores, preferred items and/or services), and any other information that may indicate shopping interests of the users. User preference information for a user may be manually provided by the user and/or may be determined by analyzing a shopping history of the user.

In another embodiment, a user may be enabled to manually form a group (e.g., by interacting with a user interface), and may open the group to other users to join. As such, in an embodiment, users may be enabled to join an existing group that was formed by another user. In another embodiment, a user may be enabled to join an existing group that was formed automatically.

In step 804, a plurality of group discount packages is offered to the group of users. For example, once a group of users is formed, group discount offering engine 304 may provide appropriate offers that meet the constraints provided by the particular group of users by transmitting and/or displaying offer messages 602a-602n to the group, as described in FIG. 6 above.

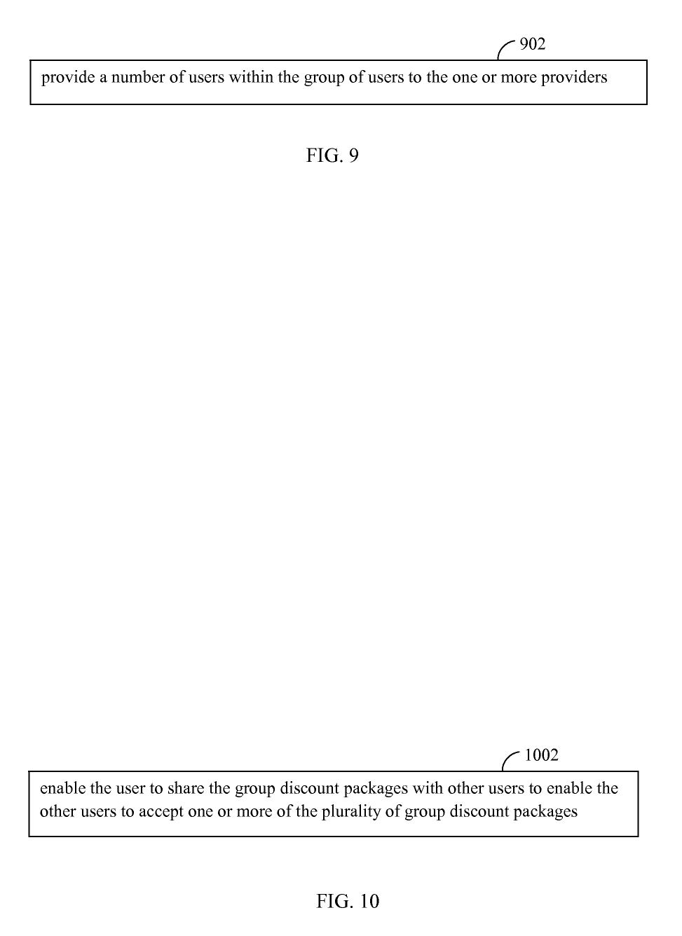

In an embodiment, statistics regarding the users and their shopping interests may be provided to providers. For instance, FIG. 9 shows a step 902 providing a process for providing statistic(s) regarding users within a group of users. In step 902, a number of users within a group of users is provided to one or more providers. For instance, in an embodiment, group discount offering engine 304 may include a statistics engine that generates and/or maintains such statistics, such as a number of users in a group and/or further statistics related to users. Group discount offering engine 304 may transmit such statistics to one or more of the providers. Providers may be more inclined to offer deals when they can analyze such statistics, such as the number of users are interested in a particular deal, the amount each user is willing to spend, the time frame during which the users would like for the deals to take place, etc. Such statistics may be helpful to the providers to gauge user interest and to determine the logistics for configuring appropriate group discount packages. Providers may also use these statistics to compete independently of one another in offering deals. For example, a provider with a large inventory may be able to offer a group discount package without any limitations. In contrast, a provider with a relatively small inventory or procurement capacity may be forced to place limitations on the number of coupons for a group discount offer that are offered so that more users do not accept the offer than can be served.

Furthermore, in an embodiment, such statistics regarding the users and their shopping interests may be provided to others of the users. For instance, one or more statistics generated/maintained by the statistics engine of group discount offering engine 304, such as a number of users interested in a particular deal, an amount each user is willing to spend, a time frame during which the users would like for the deals to take place, etc., may be transmitted to the users of a group by group discount offering engine 304. Such statistics may be provided to users for various reasons, including encouraging participation. For instance, if a user is provided with an indication of a total number of users who want a deal in a particular product category, brand, retailer etc., the user may be influenced to participate in the deal.

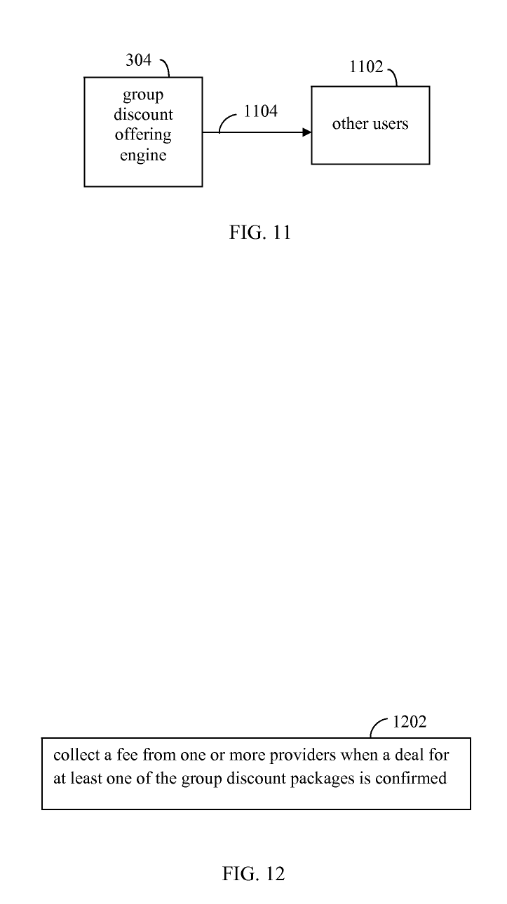

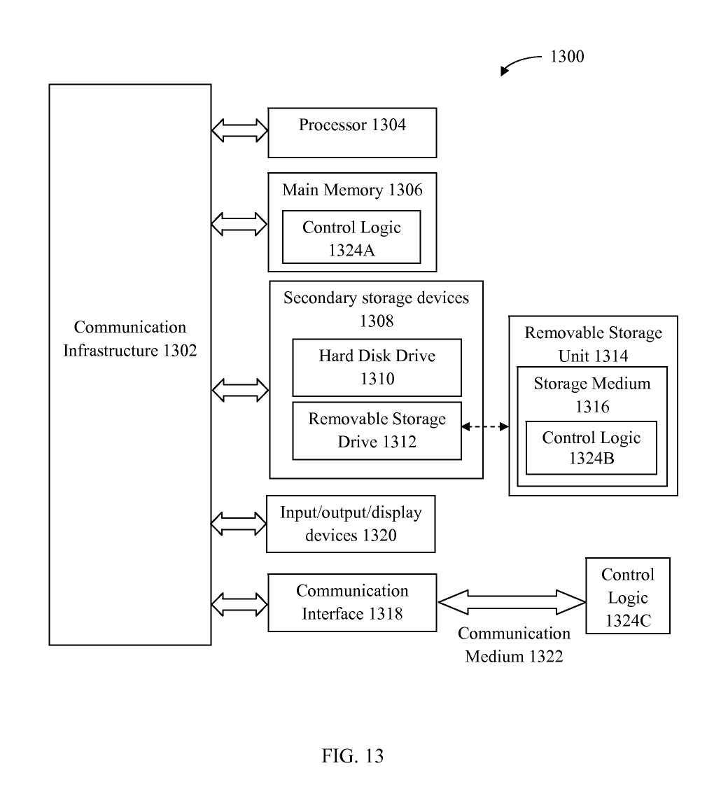

In an embodiment, users may be able to share group discount packages with other users. For instance, FIG. 10 shows a step 1002 providing a process for enabling a user to share a group discount package with other users. In step 1002, a user is enabled to share group discount packages with other users to enable the other users to accept one or more of the plurality of group discount packages. When users are allowed to share group discount coupons, they can indicate their interest in a deal to others as well as actively promoting the deal. In this manner, the predetermined threshold value associated with a group discount package may be more easily met, leading to a greater likelihood that the deal is confirmed. In an embodiment, step 1002 may be performed by group discount offering engine 304. For instance, FIG. 11 shows a block diagram where group discount offering engine 304 enables a user to share a group discount package 1104 with other users 1102, according to an example embodiment. Other users 1102 may be members of a group discounting service, a social network (e.g., Twitter®, Facebook®, Google+, or others), or other types of users. Group discount package 1104 may be shared by a user of group discount offering engine 304 clicking on a button, selecting a link, sending an email message, or any according to other form of communication. For example, as shown in FIG. 7, users may interact with user interface 702 and click on a “Share” button 704 to share the group discount package associated with offer message 602a with one or more other users.

In an embodiment, a fee may be collected from one or more providers for allowing the providers to participate in a group discounting system. For instance, FIG. 12 shows a step 1202 for providing a process for collecting a fee from one or more providers, according to an example embodiment. In step 1202, a fee is collected from one or more providers when a deal for at least one of the group discount packages is confirmed. In an embodiment, once a group discount package is confirmed (e.g., when a predetermined number of users have accepted a deal), a fee may be collected from the provider in exchange for facilitating the group discount, and/or fees may be collected from the provider at one or more other milestones. For example, in FIG. 1, when enough users have accepted a deal, a payment may be requested from the corresponding provider of provider devices 124a-124n by group discounting system 108. In one example, group discounting system 108 may request payment by generating an invoice and submitting it to the provider, by automatically deducting an appropriate amount from an account of the provider, or in another manner.

### II. Example Computer Implementations

Group discounting system 104, group discounting system 300, package configuration module 302, group discount offering engine 304, flowchart 200, flowchart 800, step 902, step 1002, step 1202, and/or any further systems, sub-systems, and/or components disclosed herein may be implemented in hardware, software, firmware, or any combination thereof. For example, group discounting system 104, group discounting system 300, package configuration module 302, group discount offering engine 304, flowchart 200, flowchart 800, step 902, step 1002, and/or step 1202 may be implemented as computer program code configured to be executed in one or more processors. Alternatively, group discounting system 104, group discounting system 300, package configuration module 302, group discount offering engine 304, flowchart 200, flowchart 800, step 902, step 1002, and/or step 1202 may be implemented as hardware logic/electrical circuitry.

As described above, group discounting systems may generate one or more user interfaces. For instance, group discounting systems may enable user input to be provided from one or more of any type of user interface elements provided by a computing device, including a keyboard, a thumb wheel, a pointing device, a roller ball, a stick pointer, a touch sensitive display, any number of virtual interface elements, a voice recognition system, etc. Graphical user interfaces (GUI) may be displayed in a display of the computing device, such as in a browser window generated by a web browser, an application window, or in other window type mentioned elsewhere herein or otherwise known.

The embodiments described herein, including systems, methods/processes, and/or apparatuses, may be implemented using well known servers/computers, such as a computer 1500 shown in FIG. 15. For example, user devices 102a-102n, server 104, and any of the sub-systems or components contained therein may be implemented using one or more computers 1500.

Computer 1500 can be any commercially available and well known computer capable of performing the functions described herein, such as computers available from International Business Machines, Apple, Sun, HP, Dell, Cray, etc. Computer 1500 may be any type of computer, including a desktop computer, a server, etc.

Computer 1500 includes one or more processors (also called central processing units, or CPUs), such as a processor 1504. Processor 1504 is connected to a communication infrastructure 1502, such as a communication bus. In some embodiments, processor 1504 can simultaneously operate multiple computing threads.

Computer 1500 also includes a primary or main memory 1506, such as random access memory (RAM). Main memory 1506 has stored therein control logic 1528A (computer software), and data.

Computer 1500 also includes one or more secondary storage devices 1510. Secondary storage devices 1510 include, for example, a hard disk drive 1512 and/or a removable storage device or drive 1414, as well as other types of storage devices, such as memory cards and memory sticks. For instance, computer 1500 may include an industry standard interface, such a universal serial bus (USB) interface for interfacing with devices such as a memory stick. Removable storage drive 1514 represents a floppy disk drive, a magnetic tape drive, a compact disk drive, an optical storage device, tape backup, etc.

Removable storage drive 1514 interacts with a removable storage unit 1516. Removable storage unit 1516 includes a computer useable or readable storage medium 1524 having stored therein computer software 1528B (control logic) and/or data. Removable storage unit 1516 represents a floppy disk, magnetic tape, compact disk, DVD, optical storage disk, or any other computer data storage device. Removable storage drive 1514 reads from and/or writes to removable storage unit 1516 in a well known manner.

Computer 1500 also includes input/output/display devices 1522, such as monitors, keyboards, pointing devices, etc.

Computer 1500 further includes a communication or network interface 1518. Communication interface 1518 enables computer 1500 to communicate with remote devices. For example, communication interface 1518 allows computer 1500 to communicate over communication networks or mediums 1542 (representing a form of a computer useable or readable medium), such as LANs, WANs, the Internet, etc. Network interface 1518 may interface with remote sites or networks via wired or wireless connections.

Control logic 1528C may be transmitted to and from computer 1500 via the communication medium 1542.

Any apparatus or manufacture comprising a computer useable or readable medium having control logic (software) stored therein is referred to herein as a computer program product or program storage device. This includes, but is not limited to, computer 1500, main memory 1506, secondary storage devices 1510, and removable storage unit 1516. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for implementing group discounting system 104, group discounting system 300, package configuration module 302, group discount offering engine 304, flowchart 200, flowchart 800, step 902, step 1002, and/or step 1202 (including any step of flowcharts 200 and 800), and/or further embodiments described herein. Embodiments of the invention are directed to computer program products comprising such logic (e.g., in the form of program code or software) stored on any computer useable medium. Such program code, when executed in one or more processors, causes a device to operate as described herein.

Note that such computer-readable storage media are distinguished from and non-overlapping with communication media (do not include communication media). Communication media typically embodies computer-readable instructions, data structures, program modules, or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

The invention can work with software, hardware, and/or operating system implementations other than those described herein. Any software, hardware, and operating system implementations suitable for performing the functions described herein can be used.

### III. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method, comprising:
receiving a shopping request from a user;
providing information related to the shopping request to a plurality of providers;
receiving a plurality of group discount packages from the plurality of providers generated based on the provided information;
offering the plurality of group discount packages by enabling the user to accept at least one of the group discount packages; and
confirming a deal for at least one of the plurality of group discount packages with a corresponding at least one of the providers when an associated threshold value is met.

2. The method of claim 1, wherein said receiving the shopping request comprises:
receiving in the shopping request an indication of at least one of a specific product, a product type, a service, a provider, or a brand; and
receiving in the shopping request a budget indicating a maximum amount of money the user is willing to spend.

3. The method of claim 1, wherein a plurality of shopping requests is received, the method further comprising:
forming a group of users having submitted shopping requests that include at least one same shopping request parameter; and
wherein said offering comprises:
offering the plurality of group discount packages to the group of users.

4. The method of claim 3, wherein said forming comprises:
forming the group of users automatically based on user preferences gathered from the group of users using information relating to the plurality of shopping requests.

5. The method of claim 3, wherein said providing information comprises:
providing a number of users within the group of users to the one or more providers.

6. The method of claim 1, wherein said receiving the plurality of group discount packages comprises:
receiving in the plurality of group discount packages
a coupon indicating at least one of a particular purchase value, a discount on a specific product, a discount on a service, a discount on a category of products, or a discount on a category of services, and
the associated threshold value representing a predetermined number of users to request to purchase a particular group discount package before the deal is confirmed for the particular group discount package.

7. The method of claim 6, wherein said confirming comprises:
confirming a deal for one of the plurality of group discount packages when the predetermined number of users accepts the one of the plurality of group discount packages.

8. The method of claim 1, wherein said confirming comprises:
confirming a deal for at least one of the plurality of group discount packages when the associated threshold value is met prior to expiration of a predetermined period; and
canceling the offer if the predetermined period expires prior to the associated threshold value being met.

9. The method of claim 1, further comprising:
enabling the user to share the plurality of group discount packages with other users to enable the other users to accept one or more of the plurality of group discount packages.

10. The method of claim 1, further comprising:
collecting a fee from one or more providers when a deal for at least one of the plurality of group discount packages is confirmed.

11. A system, comprising:
a package configuration module configured to generate a first user interface that enables a shopping request to be received from a user, a second user interface that enables information relating to the shopping request to be presented to a plurality of providers, and enables the plurality of providers to generate a plurality of group discount packages based on the shopping request; and
a group discount offering engine configured to offer the plurality of group discount packages, wherein the group discount offering engine enables the user to accept at least one of the plurality of group discount packages, and confirms a deal for at least one of the plurality of group discount packages with at least one of the providers when an associated threshold value is met.

12. The system of claim 11, wherein the first user interface enables the user to indicate at least one of a specific product, a product type, a service, a provider, or a brand; and a budget indicating a maximum amount of money the first user is willing to spend in the received shopping request.

13. The system of claim 11, wherein the package configuration module enables the plurality of providers to indicate in each of the plurality of discount packages
a coupon indicating at least one of a particular purchase value, a discount on a specific product, a discount on a service, a discount on a category of products, or a discount on a category of services, and
the associated threshold value representing a predetermined number of users to request to purchase a particular group discount package before the deal is confirmed for the particular group discount package.

14. The system of claim 13, wherein the group discount offering engine is further configured to confirm a deal for at least one of the plurality of group discount packages when the associated threshold value is met prior to expiration of a predetermined time period and is configured to cancel the offer if the predetermined time period expires prior to the associated threshold value being met.

15. The system of claim 11, wherein the group discount offering engine is further configured to form a group of users having submitted shopping requests that include at least one same shopping request parameter, and to offer the plurality of group discount packages to the group of users.

16. The system of claim 15, wherein the group discount offering engine is further configured to automatically form a group of users having submitted shopping requests based on user preferences gathered from the group of users using information relating to the shopping requests.

17. The system of claim 11, wherein the group discount offer engine is further configured to email an indication of the plurality of group discount packages to the user.

18. The system of claim 11, wherein the group discount offering engine is further configured to collect a fee from the one or more providers when a deal for at least one of the plurality of group discount packages is confirmed.

19. A computer program product comprising a computer usable medium having program code embodied in said medium for facilitating user centric group buying deals, the program code comprising:
a first program code that enables a processor to receive a shopping request from a user;
a second program code that enables a processor to provide information relating to the shopping request to a plurality of providers;
a third program code that enables a processor to receive a plurality of group discount packages from the plurality of providers generated based on the provided information;
a fourth program code that enables a processor to offer the plurality of group discount packages by enabling the user to accept at least one of the group discount packages;
a fifth program code that enables a processor to confirm a deal for at least one of the plurality of group discount packages with a corresponding at least one of the providers when an associated threshold value is met; and
a sixth program code that enables a processor to enable the user to share the plurality of group discount packages with other users to enable the other users to accept one or more of the plurality of group discount packages.

20. The computer program product of claim 19, further comprising:
a seventh program code that enables a processor to collect a fee from one or more providers when a deal for at least one of the plurality of group discount packages is confirmed.
